(19) United States
(12) Patent Application Publication
(10) Pub. No.: US 2008/0038475 A1
(43) Pub. Date: Feb. 14, 2008

(54) Method for Producing a Thermal Paper

(76) Inventors: Michael Boschert, Appenweier (DE); Michael Horn, Offenburg (DE); Gunter Pietsch, Isernhagen (DE); Rolf Weil, Oberkirch (DE)

Correspondence Address: FAY SHARPE LLP, 1100 SUPERIOR AVENUE, SEVENTH FLOOR, CLEVELAND, OH, 44114, US

(21) Appl. No.: 10/591,659

(22) PCT Filed: Mar. 4, 2005
(86) PCT No.: PCT/EP05/02330

§ 371 Date: Sep. 19, 2007

(30) Foreign Application Priority Data
Mar. 4, 2004 (DE) 10 2004 011 230.4

(51) Int. Cl. B05D 1/30

(52) U.S. Cl. 427/420

(57) ABSTRACT

The invention relates to a method for producing a thermal paper comprising a carrier substrate, an intermediate pigment coat, a thermal reaction coat and optionally one or more additional intermediate coats and/or top coats, said intermediate pigment coat being formed from a pigment, binding agents and optionally an aqueous application suspension containing additional application additives, by means of a curtain coating method. Said method is characterised in that an aqueous application suspension containing calcined kaolin, with a solid content of between approximately 25 and 75 wt. %, is applied at an operating speed of at least approximately 500 nm/min in a curtain coating method and is dried. Said method is technically simple and economical to perform. In particular, the method enables the use of the curtain coating method at a higher speed of more than 750 m/min and in particular more than 1500 m/min.

The invention relates to a method for producing a thermal paper comprising a carrier substrate, an intermediate pigment coat, a thermal reaction layer and optionally one or several additional intermediate coats and/or top coats, said intermediate pigment coat being formed with an aqueous suspension containing pigments, binding agents and optionally additional application additives by means of the curtain coating method.

A method of the above described kind is apparent from DE 101 96 052 T1. This method also employs the curtain-coating method to form different coats, in particular the addressed intermediate pigment coat. The known teaching is to replace other traditional coating methods and their related drawbacks. These traditional methods involve air-meter coating methods, spread-coating methods, rod-coating methods and reverse rolling coating methods. The therewith produced products are reported to pose problems, in particular the quality of the cover coating is said to be too poor and the top coat is said to present fine holes. The fine holes result in unwelcome heterogeneousness which leads to defective image reproduction when employed. The methods do not permit high operating speeds and, consequently, do not demonstrate desirable productivity. In DE 101 96 052 T1 it is assumed as being known that high-quality cover coats are obtainable with the curtain-coating method. Thus it is presented as desirable of utilizing a method involving high speed. The concept of “high speed” is also dealt with in DE 101 69 052 T1. However, in order to eliminate the drawbacks of the state of the art, it is necessary to employ a complicated course of action. Thus, a total of at least 3 liquid films are simultaneously applied on-line, with the middle coating film having particular importance. The middle coating film serves to isolate the two other outer coating films, which is achieved by increasing the viscosity of the two outer fluid films, which is achieved under “high velocity”. What is to be understood as “high velocity” of a curtain method also becomes evident from DE 101 96 052 T1.

Accordingly, there is no doubt that the maximum velocity that can be employed is always 200 m/min. In other words, a complex and costly method is described which permits at the most an operating speed of 200 m/min with the employed curtain-coating method. Said complex operating method to form said coatings is likely to sustain defects and is uneconomical in view of the speed of 200 m/min.

It is desirable if, on the one hand, the complicated application type is avoided according to known methods and, on the other hand, a significantly higher operating speed could be attained in order to manufacture in technically simple fashion and economically beneficial manner a process product of satisfactory quality.

Contrary to the informational data of the state of the art according to DE 101 96 052 T1, namely complex formation of addressed coatings and maintenance of an operating speed of the employed curtain-coating method of 200 m/min maximum, the present invention has found a particularly elegant solution whereby the operating speed of the curtain-coating method can clearly be more than doubled, it may even be seven times higher and more.

According to the invention, the addressed object is solved in that an aqueous application suspension containing calcined kaolin having a solid matter contents of approximately 25 to 75% by weight is applied by means of the curtain-coating method at an operating speed of at least approximately 500 m/min and dried.

The technical and commercial success to be realized according to the invention, which will be discussed in more detail later on, is particularly surprising due to the fact that calcined kaolin is known to create rheological problems with high carrier substrate velocities. These occur in particular with the earlier described methods in which the application suspension initially is applied in excess amounts and subsequently mechanically reduced to the desired measure. The application mass becomes extended, for example, cannot be spread out as desired. Application mistakes occur, also bare spots, cloudiness when the spreadable mass is applied, dry-run of the wiper device and similar. In making use of said special calcined kaolin as principal component of the intermediate pigment coat, one could not anticipate according to any point of view that the assigned object would be solved so completely and in such surprising manner by applying the curtain-coating method with unusually high operating speed.

The inventors of the claimed method have attempted, using multiple pigments customary in current technology, to produce a beneficial product in simple and economical manner. In so doing, it has turned out as a surprise that the calcined kaolin is of special benefit.

For example, the pigments calcium carbonate, aluminum oxide, magnesium carbonate and similar products do not deliver the desired effects, in particular no adequate color intensity of the thermal coating applied on the intermediate coat, due to poor thermal insulation behavior of these pigments during thermal printing. The calcined kaolin, which is used according to the invention is, therefore, of particular value because it presents by its calcination a beneficial leaf structure, which permits favorable micro-air inclusions, which leads to improved thermal isolation behavior during thermal printing.

The thermal rays are stored and reflected, so that the thermal energy is available, to the extent possible, for color formation reactions in the thermal reaction layer. In general, beneficial results are achieved if the medium grain size d₅₀ amounts to approximately 1.0 to 3.0 μm (measured according to the laser-diffraction measuring method).

When implementing the invention-specific method, it is appropriate that the aqueous application suspension containing the calcined kaolin presents a solid matter contents of approximately 25 to 75% by weight, with a solid matter contents of approximately 35 to 60% by weight being preferred. If the upper value is surpassed, a viscosity of the application suspension sets in, which will affect advantageous process control or even renders same impossible. Falling short of the value by approximately 25% by weight does not result in the desirable productivity. The application suspension containing calcined kaolin is particularly adjusted to the following beneficial basic conditions:

It should have a viscosity of approximately 150 to 1500 mPas (Brookfield, 100 U/min, 25° C.), in particular of approximately 250 to 900 mPas, particularly also with respect to the above ascertained determinations in regard to basic conditions of the solid matter contents of the application suspension. In addition, it is of benefit if the surface tension of the application suspension is adjusted to between approximately 23 and 60 mN/m, in particular between approximately 27 and 40 mN.m (static ring method according to Du Noüy). Moreover, in individual instances it is of advantage if traditional additives in form of processing aids are incorporated into the aqueous application suspension containing the calcined kaolin, in particular in the form of surface-active substances, of retention aids and/or rheological aids. In general and preferably among the surface-active substances first choice is given to the carboxy-methyl-celluloses and the poly-acrylamides, among the rheological aids, to the higher molecular, water-soluble starch derivatives, carboxy-methyl-celluloses, sodium-alginates, polyvinyl-alcohols and poly(meth)acrylates.

In regard to the particle size of the calcined kaolin, the invention is not subject to any significant restriction. In keeping with the rules and it is appropriate that the particle size lies between approximately 0.1 and 10 μm, in particular between approximately 0.1 and 2 μm. If the value of 10 μm is surpassed, this generally leads to a deficiency in smoothness or to an unwelcome rough surface. Moreover, the resolution is affected in image reproduction. If the value falls short of approximately 0.1 μm, the reflection of the image is affected, in particular the color intensity.

Also in the selection of the respective carrier substrate, the invention is not subject to any significant restriction. In principle, the traditional carrier substances can be utilized. This may involve, for example, a customary paper carrier, on cellulose fiber basis, but also a synthetic paper carrier, whose fibers consist entirely or partially of plastic fibers. Basically, this may also involve a plastic foil. The basis weight of the carrier is not subject to any significant restriction. When selecting traditional paper carriers, it is of benefit that their basis weight lies between approximately 40 and 120 g/m². Preferred is a long fiber percentage of up to approximately 40% by weight, in particular between approximately 5 and 40% by weight, and a short fiber percentage ranging between approximately 60 and 95% by weight, in particular between approximately 60 and 80% by weight. The long fiber portion results in solidity enhancement of the carrier paper.

The aqueous application solution, containing calcined kaolin, which is used to form the intermediate pigment coat contains a mandatory binding agent. It is preferred if the binding agent is in the form of water-soluble starches, starch derivatives, hydroxyl-ethyl-celluloses, polyvinyl-alcohols, modified polyvinyl-alcohols, sodium poly-acrylates, acrylamide-(meth)acrylate-copolymers, acrylamide-acrylate-methacrylate-terpolymers, alkali salts of styrene-maleic-acid-anhydride-co-polymers and/or alkali salts of ethylene-maleic acid anhydride-co-polymers. Such materials produce a layer which is water soluble. On the other hand, in addition to these materials there exist also those which result in a water insoluble structure when forming the intermediate coats. This involves, for example, lattices such as poly-acrylate-ester, poly-styrene-acrylate-ester-co-polymers, styrene-butadien-copolymers, poly-urethane, acrylate-butadien-co-polymers, polyvinyl-acetate and/or acryl-nitril-butadien-co-polymers and similar. The binding agent serves in all instances for favorably joining the addressed intermediate coat with the carrier substrate, but also for assuring optimum bonding with the coat which follows.

It is within reasoning of a person skilled in the art to select in individual instances a particularly suitable binding agent or a binding agent mixture.

There is no critical limitation on the application weight of the application suspension containing calcined kaolin. It is of benefit if a maximum value of approximately 40 g/m² is not exceeded relative to the dry substance. If the value of approximately 30 g/m² is surpassed, that proves to be economically unfavorable since there is no relevant improvement in the targeted effects. It is particularly preferred if the maximum value lies at about 25 g/m². The optimized application weight lies between approximately 2 and 15 g/m² relative to dry substance, in particular between approximately 3 and 8 g/m².

In some cases it turned out that if certain so-called diluent pigments are mixed with the calcined kaolin in the aquaeous application suspension for the formation of the intermediate pigment coat, this results, for example in cost optimization in order to have a beneficial effect on certain rheological properties, such as, for example, the flow behavior of the application suspension. This may involve inorganic as well as organic pigments.

Preferred among the inorganic pigments are natural or precipitated calcium carbonate, clays, siliceous earth, aluminum oxides, silicic acid, magnesium silicates, magnesium carbonates and similar. Among the organic pigments, pigments which present hollow spheres have proven themselves as particularly advantageous. The wall of these hollow spheres consists preferably of styrene-acrylate-co-polymers. Organic pigments, even if they do not have said hollow spaces, may also be given consideration, such as for example condensates of urea formaldehyde and similar.

In some cases it is of benefit if one or several additional intermediate pigment coats are formed by means of the curtain coating method on the first intermediate pigment coat, making use of a calcined kaolin containing application suspension, whereby the sequence of the intermediate coats may be changed depending upon pursued objective.

The course of action may involve that directly following formation of the first moist intermediate pigment coat, one or several additional moist intermediate pigment coats are formed, after which follows an overall drying step. On the other hand, there exists the possibility that the first formed intermediate coat is dried and then the subsequent coats are formed and dried. The curtain-coating method is preferably applied here as well, which offers diverse technological possibilities concerning liquid film formation or liquid film exit from the curtain coater head. It is basically also possible to utilize, if appropriate, other suitable methods for the formation of these additional intermediate coats.

The above addressed coats can be produced on-line or in a separate coating step, off line, which may also be done simultaneously. The same applies with respect to the drying process. The same applies in regard to the formation of the thermal reaction layer required for the thermal paper. The curtain-coating method is thus preferably used subject to the described conditions for the formation of the thermal reaction layer, using an appropriate aqueous application suspension with incorporation of conventional additives, which either advantageously affect the application itself or the properties of the final product. In addition to the required color producers and color developers and binding agents, said aqueous application suspension may potentially contain, for example, sensitizing melting auxiliaries, additional customary additives, such as in particular slip additives, rheological auxiliaries, optical brighteners and/or fluorescent substances.

It is preferred that the color producers are present in the form of 2-anilino-3-methyl-6-diethylamino-fluoran, 2-anilino-3-methyl-6-di-n-butylamino-fluoran, 2-anilino-3-methyl-6-(N-ethyl-,N-p-toluidino-amino)-fluoran, 2-anilino-3-methyl-6-(N-methyl-,N-propyl-amino)-fluoran, and/or 3,3-bis-(4-dimethylamino-phenyl)-6-dimethyl-amino-phthalide, the color developers in the form of phenol derivatives such as 2,2-bis-(4-hydroxyphenyl)-propane, bis-(4-hydroxyphenyl)-sulfone, 4-hydroxy-4′-iso-propoxy-diphenyl-sulfone, bis-(3-allyl-4-hydroxy-phenyl)-sulfone, 2,2-bis-(4-hydroxyphenyl)-4-methyl-pentane, N-(benzolsulfonyl)-N′-(3-p-toluol-sulfonyl-oxyphenyl)-urea, salts of zinc from derivatives of the salicylic acid, the binding agents in the form of water-soluble starches, starch derivatives, hydroxy-ethyl celluloses, polyvinyl-alcohols, sodium-poly-acrylates, sodium-alginates, acrylamide-(meth)acrylate-co-polymers, acrylamide-acrylate-methacrylate-terpolymers, alkali salts of styrene-maleic anhydride co-polymers, alkali salts of ethylene-maleic anhydride-co-polymers and/or lattices, such as poly-acrylate, poly(meth)acryl-acid-esters, styrene-butadien-co-polymers, polyurethanes, acrylate-butadien-co-polymers, polyvinyl-acetate and/or acryl nitril-butadien-co-polymers, the sensitizing melting auxiliaries in the form of the following substances, for example such as 2-benzyl-oxy-napthaline (BON), m-terphenyl, p-Benzylbiphenyl (PBBP), oxalic acid di-benzyl-ester, oxalic acid-di-(p-methyl-benzyl)-ester,

1,2-bis(phenoxy-methyl)-benzol, 4-(4-tolyloxy)-biphenyl, ethylene-glycol-diphenylether, ethylene-glycol-m-tolyl-ether, 1,2-bis-(3,4-di-methyl-phenyl)-ethane, the slip additives in the form of fatty acid amides, such as for example stearine acid amide, fatty acid alcanolamides, such as for example stearic acid methylolamide

ethylene-bis-alkanolamides, such as for example ethylene-bis-stearoylamide, synthetic waxes, such as for example, paraffin waxes of different melting points, ester waxes having different molecular weights, ethylene waxes, propylene waxes of different hardnesses or also natural waxes, such as for example, carnuba wax and/or fatty acid metallic soaps, such as for example zinc stearate, calcium stearate or also behenolic acid salts, the rheological auxiliaries in the form of water-soluble hydro-colloids such as starches, starch derivatives, sodium alginates, polyvinyl-alcohols, carboxy-methyl-cellulose, poly(meth)acrylates, the optical brighteners in the form of white dyes, for example from the substance groups diamino-stilbene-di-sulfonic acid, distyryl-biphenyls, benzoxazol derivatives, the fluorescent substances in the form of day light glow pigments of various color shades or fluorescent fibers, the anti-aging means in the form of stearic impeded phenols, such as for example, 1,1,3-tris-(2-methyl-4-hydroxy-5-cyclohexyl-phenyl)-butane, 1,1,3-tris-(2-methyl-4-hydroxy-5-tert.-butylphenyl)-butane, 1,1-bis-(2-methyl-4-hydroxy-5-tert.-butyl-phenyl)-butane, 1,1′-bis-(4-hydroxy-phenyl)-cyclo-hexane.

Consideration of optimum drop height for successful implementation of the invention-specific method leads to its enhancement as well. Thus, preference is given to adjusting the drop height of the application suspension for the formation of the thermal reaction layer when executing the curtain-coating method to approximately 5 to 35 cm, in particular to approximately 8 to 20 cm. The aqueous application suspension for the formation of the thermal reaction layer preferably has a surface tension between approximately 25 to 60 mN/m, in particular between 30 to 40 mN/m (statistical ring method according to Du Noüy).

After obtaining the dried thermal reaction layer, it is appropriate to smooth it using customary smoothing means. In so doing, it is useful if the Bekk smoothness (measured according to DIN 53101 is adjusted to approximately 100 to 1200 sec, in particular to approximately 300 to 700 s). In addition to the above mentioned components or essential elements which are comprised in the application suspension for formation of the thermal reactionlayer, said application suspension can contain further pigments, in particular extender pigments. These serve for optimizing the image reflection and also to improve adsorption of the melt which develops during thermal print. In addition, properties are enhanced such as capability of being written on, capability of being printed on, whiteness and smoothing ability.

Among the particularly suitable extender pigments are inorganic pigments, such as in particular clays, calcined clays, calcium carbonates, sodium aluminum silicates, aluminum oxides, titanium di-oxides, silicic acids, siliceous earths, magnesium silicates of synthetic as well as natural origin. These have preferably an average particle size of approximately 0.1 to 10 μm, in particular of approximately 0.1 to 2 μm. Surpassing the value of 10 μm may lead to unwelcome increase in roughness, while falling short of the value of 0.1 μm will affect the color intensity in reproduction of the image.

Basically, with the formation of the mentioned thermal reaction layer, there exists a thermal paper which is able to function. However, practical purposes demand, on a regular basis that additional coats are being formed, on-line or off-line, as protective coat and/or as a coat which enhances the printability.

The method according to the invention is particularly beneficial because with employment of the curtain-coating method the production process with comparably high velocity of 500 m/min will lead to beneficial operational-economic and technical results.

The economy is, as a result, further improved, in that it can run also with a velocity of more than 750 m/min and in particular with a velocity of at least approximately 1000 m/min. The inventors ascertained with particular surprise that even a velocity in excess of 1500 m/min will result in a perfectly good process product, without being able to determine any drawbacks during production. The targeted results are specifically attained if the clear exit gap width of the curtain spreader head of the curtain coating method is adjusted to approximately 0.1 to 1 mm, in particular to approximately 0.2 to 0.6 mm, and/or the nozzle through-puts for the respective application suspension are adjusted to approximately 0.3 to 15.1 cm³/(cm working width×s), in particular to approximately 0.5 to 5.0 cm³/(cm×s), whereby the curtain spreader head can be operated with a single- or multiple gap.

The benefits which are related to the present invention can basically be summarized as follows:

The method is economically of high advantage. This is particularly due to the ability of being operated at extremely high speed with up to more than 1500 m/min without appearance of any relevant impairments of the sought-after properties of the process product. Moreover, it is possible for the first time to employ the particularly beneficial calcined kaolin in an intermediate coat of a thermal paper while operating the production method at high operating speed. That was not possible with the known methods because of rheological problems. In addition, the entire bonding system can be designed making use of the method operated at high speed. This may be done on-line as well as off-line, which provides a certain degree of flexibility in control of the process. What is of particular surprise is that the properties of the process product are highly satisfactory. This applies in particular with respect to the image reflection as well as ability to print the paper and also insofar as economy of the paper production process is concerned.

The invention is described below in detail, making use of examples, but is not limited to said examples:

### EXAMPLES

Application of a coating suspension for the formation of an intermediate pigment coat of a thermal paper was effected by means of the curtain-coating method. The clear exit gap width of the curtain spreader head amounted to 0.3 mm (single spreader head). The curtain spreader head was operated with a nozzle through-put for the application suspension of approximately 0.35 cm³/cm (work width×s). The viscosity of the aqueous application suspension amounted 500 mPas (according to Brookfield, 100 U/min, 25° C.), adjusted (in not de-aerated state). The surface tension of the application suspension amounted to 37 mN/m (statistical ring method). The spreader mechanism was arranged in-line. Application of the aqueous application suspension was effected on a paper web having a basis weight of 43 g/m². The drop height of the application suspension was set at 13 cm. The curtain-coating method was operated at a speed of 1200 m/min. In addition, the aqueous application suspension or the thread length was adjusted in the Ford-Beaker (nozzle 4) to a range of 92 cm.

After application of the application suspension, the drying process of the coated paper carrier took place in the usual manner.

Based on the preceding information, a thermal paper was produced with the following recipes of aqueous application suspension being used for forming a bonded composite having an intermediate pigment coat on a carrier substrate, with subsequent formation in traditional fashion of additional layers, in particular the thermal reaction layer. The latter is not going to be discussed in more detail inasmuch as it does not affect the core concept of the invention.

Recipe 1:

An aqueous application suspension containing calcined kaolin was used based on the above described process method in order to produce a bonded composite of paper carrier and intermediate pigment coat.

| | Wet Mass | |
|---|---|---|
| | 100% | Oven Dry |
| Recipe | Kg | kg |
| Water | 27.8 | — |
| Dow Latex (48.5%)*¹ | 21.0 | 10.18 |
| Hubertex (100%)*² | 34.4 | 34.40 |
| Na-carboxy-methyl cellulose (0.7%)*³ | 16.0 | 0.11 |
| Blankophor PO1 (26.4%)*⁴ | 0.5 | 0.13 |
| Succinate (0.05%)*⁵ | 0.3 | 0.0015 |
| Application Mass | 100.0 | 44.8215 |

Note:
All specifications refer to oven dry weight in %.
Notations:
These compositions stand for the following:
*¹binding agent of the styrene-butadien latex type
*²calcined kaolin
*³carboxy-methyl cellulose, rheological auxiliary, 0.7% aqueous solution Brookfield-Viscosity (1%): 3 000-6 000 mPas at 25° C., sp. 4/30 U min
*⁴optical brightener, whitening means
*⁵surface active agent

The above indicated application mass yields a dry contents of approximately 44.8% by weight. Additional specifications: pH value 7.4 to 7.8; viscosity (according to Brookfield 100 U/min, spindle 3, 20° C.) 400 mPas, surface tension (at 20° C.) 36 mN/m, thread length (in Ford beaker with nozzle 4) 100 cm. Application was effected with 6.9 g/m (oven dry) on the paper carrier.

Recipe 2:

The composition was the same as for Recipe 1 with the exception that as calcined clay, Ansilex 93 was used instead of Hubertex.

The application mass according to recipe 2 produced the following characteristic figures:

Dry Contents of approximately 43.1% by weight

pH value 6.9-7.4; viscosity (according to Brookfield 100 U/min, spindle 3, 20° C.) 450 mPas, surface tension (at 20° C.) 36 mN/m, thread length (in Ford beaker with nozzle 4) 100 cm.

Application was made with 7.0 g/m² (oven dry) on the paper carrier.

Recipe 3:

The composition of recipe 3 was the same as for recipe 2, with the exception that the ansilex 93 pigment was replaced at 20% by an organic hollow sphere pigment Ropaque.

The application mass according to recipe 3 yielded the following characteristic figures:

Dry contents of approximately 35.5% by weight

pH value 6.9-7.4; viscosity (according to Brookfield 100 U/min, spindle 3, 20° C.) 300 mPas, surface tension (at 20° C.) 34 mN/m, thread length (in Ford beaker with nozzle 4) 100 cm).

Application was effected with 6.3 g/m² (oven dry) on the paper carrier.

1. Method for producing a thermal paper comprising a carrier substrate, an intermediate pigment coat, a thermal reaction layer and, optionally, one or several additional intermediate coats and/or top coats, wherein the intermediate pigment coat is formed via the curtain-coating method with an aqueous suspension containing pigments, binding agents and, optionally, additional application additives, characterized in that an aqueous application suspension containing calcined kaolin having a solid matter contents of approximately 25 to 75% by weight is applied by means of the curtain-coating method at an operating speed of at least 500 m/min and dried.

2. Method according to claim 1, characterized in that the solid matter contents of the application suspension lies between approximately 35 and 60% by weight.

3. Method according to claim 1, characterized in that the drop heights of the aqueous application suspension containing the calcined kaolin is adjusted during execution of the curtain-coating method to approximately 5 to 34 cm, in particular to approximately 8 to 20 cm.

4. Method according to claim 1, characterized in that the application suspension containing the calcined kaolin is adjusted to a viscosity of approximately 150 to 1500 mPas (Brookfield, 100 U/min, 25° C.), in particular of approximately 250 to 900 mPas.

5. Method according to claim 1, characterized in that the surface tension of the application suspension containing the calcined kaolin is adjusted to approximately 23 to 60 mN/m, in particular to approximately 27 to 40 mN/m (static ring method according to Du Noüy).

6. Method according to claim 1, characterized in that as carrier substrate a customary carrier paper, a synthetic carrier paper and/or a plastic foil is used, with the paper carrier in particular presenting a basis weight of approximately 40 to 120 g/m².

7. Method according to claim 6, characterized in that the paper carrier contains for stabilization of dimensions synthetic fibers in addition to natural cellulose fibers, with the long fiber percentage amounting up to approximately 40% by weight, in particular to approximately 5 to 40% by weight, and the
short fiber percentage amounting to approximately 60 to 95% by weight, in particular to approximately 60 to 80% by weight.

8. Method according to claim 1, characterized in that into the application suspension containing the calcined kaolin are incorporated customary additives in the form of processing auxiliaries, in particular in form of surface-active substances, retention auxiliaries and/or rheology auxiliaries.

9. Method according to claim 8, characterized in that the surface-active substances are employed in the form of C₂-C₁₂-di-alkylsulfosuccinate-alkali salts or siloxanes, the retention auxiliaries in the form of carboxy-methyl celluloses or poly-acrylamides and/or the rheology auxiliaries in the form of higher molecular, water-soluble starch derivatives, carboxy-methyl celluloses, sodium alginates, polyvinyl alcohols or poly(meth)acrylates.

10. Method according to claim 1, characterized in that the calcined kaolin of the aqueous application suspension presents a particle size of approximately 0.1 to 10 μm, in particular of approximately 0.1 to 2 μm.

11. Method according to claim 1, characterized in that the aqueous application suspension containing calcined kaolin contains a binding agent in the form of water-soluble
starches, starch derivatives, hydroxyl-ethyl-celluloses, polyvinyl-alcohols, modified polyvinyl-alcohols, sodium-polyacrylates, acrylamide-(meth)acrylate-co-polymers, acrylamide-acrylate-methacrylate-terpolymers, alkali salts of styrene-maleic anhydride-co-polymers, alkali salts of ethylene-maleic anhydride-co-polymers and/or lattices such as poly-acrylate, styrene-butadien-co-polymers, polyurethanes, acrylate-butadien-co-polymers, polyvinyl-acetate and/or acryl-nitril-butadien-co-polymers.

12. Method according to claim 1, characterized in that the application weight of the aqueous application suspension containing the calcined kaolin is adjusted to up to approximately 30 g/m², relative to the dry substance, in particular to up to approximately 25 g/m².

13. Method according to claim 12, characterized in that the application weight of the aqueous application suspension containing the calcined kaolin is
adjusted to up to approximately 2 to 20 g/m², relative to the dry substance, in particular to approximately 4 to 8 g/m².

14. Method according to claim 1, characterized in that on the intermediate pigment coat, optionally after drying, there are formed one or several additional intermediate pigment coats by means of the curtain-coating method.

15. Method according to claim 1, characterized in that on the intermediate pigment coat or intermediate pigment coats there is formed simultaneously on-line, or in a separate spreader step off-line, a thermal reaction layer by means of the curtain-coating method or by means of a roller coating method or by means of a roller spread coating method or by means of an air brush method.

16. Method according to claim 15, characterized in that into the aqueous application suspension utilized for forming the thermal reaction layer are incorporated color developers, color formers, sensitizing melt auxiliaries, anti-aging means, binding agents and customary additives, such as in particular slip additives, rheological auxiliaries, optical brighteners and/or fluorescent substances.

17. Method according to claim 15, characterized in that the drop height of the aqueous application suspension for the formation of the thermal reaction coat is adjusted to approximately 5 to 35 cm during execution of the curtain-coating method, in particular to approximately 8 to 20 cm.

18. Method according to claim 15, characterized in that the application suspension for the formation of the thermal reaction layer is adjusted to a viscosity of approximately 150 to 1500 mPas (Brookfield, 110 U/min, 25° C.) in particular to approximately 250 to 900 mPas.

19. Method according to claim 15, characterized in that the surface tension of the application suspension for the formation of the thermal reaction layer is adjusted to approximately 23 to 60 mN/m, in particular to approximately 30 to 40 mN/m (statical ring method according to Du Noüy).

20. Method according to claim 15, characterized in that the dried thermal reaction layer is adjusted using customary smoothing means to a Bekk smoothness of approximately 100 to 1200 s, in particular of approximately 300 to 700 s, measured according to DIN 53101.

21. Method according to claim 15, characterized in that the aqueous application suspension utilized for the formation of the thermal reaction coat contains, in addition, further pigments.

22. Method according to claim 21, characterized in that the pigments represent inorganic extender pigments, in particular clays, magnesium carbonates, sodium aluminum silicates, aluminum oxides, aluminum silicate, silicic acid, siliceous earth, magnesium silicates, titanium dioxides, calcium carbonates of synthetic as well as natural origin.

23. Method according to claim 22, characterized in that the extender pigments have an average particle size of approximately 0.1 to 10 μm, in particular approximately 0.1 to 2 μm.

24. Method according to claim 14, characterized in that on the thermal reaction layer, additional layers are formed on-line or off-line as protective coat and/or as coat to enhance the capability of being printed on.

25. Method according to claim 1, characterized in that the curtain-coating method is operated at a speed of more than 750 m/min.

26. Method according to claim 25, characterized in that the curtain-coating method is operated at a speed of at least approximately 1000 m/min, in particular approximately 1500 m/min.

27. Method according to claim 1, characterized in that the clear exit gap width of the curtain spreader head of the curtain-coating method is adjusted to approximately 0.1 to 1 mm, in particular to approximately 0.2 to 0.6 mm, and/or the nozzle through-puts for the respective application suspension are adjusted to approximately
0.3 to 15.1 cm³ (cm working width×s), in particular to approximately 0.5 to 5.0 cm³/(cm×s) with the curtain spreader head being adjustable to accommodate a single- or multiple gap.
